(19) United States
(12) Patent Application Publication
(10) Pub. No.: US 2019/0026937 A1
(43) Pub. Date: Jan. 24, 2019

(54) SYSTEM AND METHOD FOR INTERACTIVE VIRTUAL LIGHTING OF A VIRTUAL SAMPLE REPRESENTATIVE OF A REAL-LIFE MANUFACTURED OBJECT

(71) Applicant: ARCANE TECHNOLOGIES INC., Québec, Québec (CA)

(72) Inventors: Mathieu BENOÎT, Québec, Québec (CA); Jean-François LAVOIE, Québec, Québec (CA)

(21) Appl. No.: 16/070,947

(22) PCT Filed: Jan. 18, 2017
(86) PCT No.: PCT/CA2017/050056

§ 371 Date: Jul. 18, 2018

Related U.S. Application Data
(60) Provisional application No. 62/279,989, filed on Jan. 18, 2016.

(51) Int. Cl. G06T 15/50; G06T 19/20; G06T 19/00

(52) U.S. Cl. CPC G06T 15/506; G06T 2215/16; G06T 19/006; G06T 19/20

(57) ABSTRACT

A system for interactive virtual lighting of a virtual sample representative of a real-life manufactured object, based on data relative to the real-life manufactured object. A lighting calibration module generates user lighting condition data representative of current lighting conditions and adjusts parameters of a virtual light source according thereto. A user interaction module captures displacement inputs from the electronic graphical communication device and generates user interaction data therefrom used by a real time rendering engine to move the virtual sample. The real time rendering engine simulates light interaction from the virtual light source with the virtual sample and processes the light interaction data to simulate light interaction from the virtual light with the virtual sample. A computer implemented method for interactive virtual lighting of a virtual sample representative of a real-life manufactured object is also provided.

### CROSS REFERENCE TO RELATED APPLICATION

This application claims the benefit under 35 U.S.C. § 119(e) of U.S. provisional patent application No. 62/279.989 which was filed on Jan. 18, 2016. The entirety of the aforementioned application is herein incorporated by reference.

### TECHNICAL FIELD OF THE INVENTION

The present invention relates to the field of interactive virtual representation of real-life objects. More particularly, it relates to a system for providing virtual representation and lighting of a virtual sample representative of a real-life manufactured object and to a method for providing the same.

### BACKGROUND

In the field of manufactured objects such as, without being limitative, flooring, countertop surfaces, composite panels, decorative surfaces, textiles and the like, physical samples of the products have historically been used to present a plurality of different products available for purchase to potential buyers and help them choose between the possible available options. Such physical samples allow comparison of products based on several criteria including color, surface texture, surface light reflection properties, surface feel, etc.

Currently, more and more, manufacturers and distributors however wish to move away from physical samples and rather wish to display virtual representations of the plurality of different products available for purchase to potential buyers. For example, the virtual representations of the manufactured products can be displayed using printed sources such as flyers, and digital sources such as pictures, videos, virtual samples and the likes, which can be seen using communication devices. Such virtual representations however tend to suffer from several drawbacks. For example, arbitrary choices have to be made regarding color reproduction and lighting conditions of the virtual material, given that the lighting conditions under which the potential buyer will look at the virtual material are unknown, the parameters of the display monitor of the communication device used to display the virtual representations of the manufactured products are also unknown and the display monitor is seldom color calibrated. Thus, the color and/or lighting of the virtual representations of the manufactured products is often not accurate and results in a material which does not look as it would if it actually was in the hands of the potential buyer.

Moreover, static pictures and videos do not allow interactive control over the virtual material and thus can only represent the texture and light reflection properties of the material in a very limited way. Static pictures and videos do not allow manipulation of the sample which causes variation in light reflection, similar to when a potential buyer manipulates a physical sample to cause variation in light reflections on the sample to evaluate the texture and the light reflection properties thereof.

Virtual representation of real-life objects is common in video games and the entertainment industry, such as animated movies and the like. In these industries, the techniques used however have no need or requirement to match existing real-world manufactured products. The approach is therefore targeted at reproducing pseudo-realistic generic natural materials such as wood or stone, but does not require the precise matching with an existing real-life manufactured object.

In view of the above, there is a need for an improved system and method for interactive virtual lighting of a virtual sample representative of a real-life manufactured object, which would be able to overcome or at least minimize some of the above-discussed prior art concerns.

### BRIEF SUMMARY OF THE INVENTION

According to a first general aspect, there is provided a system for interactive virtual lighting of a virtual sample representative of a real-life manufactured object, on an electronic graphical communication device operatively connected to a display monitor, based on light interaction data and material color data relative to the real-life manufactured object. The system comprises a lighting calibration module, a user interaction module and a real time rendering engine. The lighting calibration module generates user lighting condition data representative of the current lighting conditions of an immediate environment of a user and is configured to adjust at least one parameter of a virtual light source lighting the virtual sample according to the lighting condition data. The user interaction module captures real-time virtual object displacement inputs from the electronic graphical communication device and generates real-time user interaction data therefrom. The real time rendering engine simulates light interaction from the virtual light source with the virtual sample. The real time rendering engine also repeatedly moves the virtual sample according to the real-time user interaction data and concurrently repeatedly processes the light interaction data to simulate light interaction from the virtual light with the virtual sample.

In an embodiment, at least one parameter of the virtual light source lighting the virtual sample comprises at least one of a light color and a light intensity.

In an embodiment, the lighting calibration module is further configured to receive lighting condition inputs from an input device of the electronic graphical communication device and generate the user lighting condition data representative of the current lighting conditions of the immediate environment of the user based on the received lighting condition inputs.

In an embodiment, the lighting calibration module is configured to receive the lighting condition inputs from user controlled lighting adjustment controls. The lighting calibration module comprises a lighting calibration interface in which a virtual image representative of a physical object in possession of the user and the lighting adjustment controls are displayed on the display monitor and repeatedly adjusts at least one parameter of a virtual light lighting the virtual image representative of the physical object in possession of the user on the display monitor according to user inputs from the lighting adjustment controls.

In an embodiment, the lighting calibration module is configured to receive the lighting condition inputs from at least one light capture component operatively connected to the electronic graphical communication device.

In an embodiment, the system further comprises a display calibration module, the display calibration module being configured to perform color calibration based on a device color profile specific to one of the display monitor or the electronic graphical communication device.

In an embodiment, the display calibration module is configured to calibrate the colors of the display monitor based on the device color profile specific to the one of the display monitor or the electronic graphical communication device display monitor.

In an embodiment, the display calibration module is configured to adjust the material color data of the real-life manufactured object based on the device color profile specific to the one of the display monitor or the electronic graphical communication device.

In an embodiment, the system further comprises a light interaction module configured to measure light interaction parameters of the real-life manufactured object and generate the light interaction data and material color data therefrom.

In an embodiment, the light interaction module comprises a light interaction measuring instrument operative to measure the light interaction parameters of the real-life manufactured object.

In an embodiment, the light interaction measuring instrument comprises at least one of a flat scanner and a 3D scanner.

In an embodiment, the light interaction module further comprises: a camera having color sensitivity parameters substantially similar to the color sensitivity of the human eye, the camera being operatively connected to the electronic graphical communication device and being operative to record images of the real-life object and a preliminary virtual sample displayed on a color calibrated display monitor based on the generated light interaction data and material color data; and a light interaction tuning unit receiving the images recorded by the camera and iteratively comparing image data of the real-life object and the preliminary virtual sample from the images and adjusting the parameters of the light interaction data and material color data until a matching threshold is met.

According to another general aspect, there is also provided a computer implemented method for performing interactive virtual lighting of a virtual sample representative of a real-life manufactured object, on an electronic graphical communication device having a display monitor and based on light interaction data and material color data of the real-life manufactured object. The method comprises the steps of: generating lighting condition data representative of the current lighting conditions of an immediate environment of a user and adjusting at least one parameter of a virtual light source lighting the virtual sample based on the lighting condition data; capturing real-time virtual object displacement inputs from the electronic graphical communication device and generating real-time user interaction data therefrom; repeatedly moving the virtual sample on the display monitor according to the real-time user interaction data; and repeatedly processing the light interaction data to simulate light interaction with the virtual sample on the display monitor.

In an embodiment, generating lighting condition data representative of the current lighting conditions comprises: displaying a virtual image representative of a physical object in possession of the user and at least one lighting adjustment control on the display monitor; adjusting at least one parameter of the virtual light source lighting the virtual image, using the at least one lighting adjustment control, to adjust the lighting of the displayed virtual image representative of the physical object, until the color and lighting of the physical object in the current lighting conditions and the color and lighting of the displayed virtual image visually match; and generating the lighting condition data based on the adjustment of the at least one parameter of the virtual light source lighting the virtual image.

In an embodiment, generating lighting condition data representative of the current lighting conditions comprises acquiring lighting condition input from at least one light capture component and generating the lighting condition data based on the received lighting condition input.

In an embodiment, the computer implemented method further comprises the step of performing color calibration based on a device color profile specific to one of the display monitor or the electronic graphical communication device.

In an embodiment, performing color calibration comprises calibrating the colors of the display monitor based on the device color profile specific to the one of the display monitor or the electronic graphical communication device display monitor.

In an embodiment, performing color calibration comprises adjusting the material color data of the real-life manufactured object based on the device color profile specific to the one of the display monitor or the electronic graphical communication device.

In an embodiment, the computer implemented method further comprises: measuring light interaction parameters of the real-life manufactured object; generating the light interaction data and material color data therefrom; and storing the light interaction data and the material color data.

In an embodiment, the computer implemented method further comprises validating at least one of the light interaction data or material color data and updating the at least one of the light interaction data or material color data.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a block diagram showing a system for interactive virtual lighting of a virtual sample representative of a real-life manufactured object (hereinafter “the interactive virtual lighting system”), according to an embodiment.

FIG. 2 is a block diagram, showing the interactive virtual lighting system of FIG. 1, installed on an electronic graphical communication device.

FIG. 3 is a block diagram, showing the interaction between data and modules of the interactive virtual lighting system of FIG. 1.

FIG. 4 is an image of a virtual sample representative of a real-life manufactured object displayed on an electronic graphical communication device, according to an embodiment.

FIG. 5 is an image of a lighting calibration interface in accordance with an embodiment.

FIG. 6 is a flow chart illustrating the steps of a computer-implemented method for interactive virtual lighting of a virtual sample representative of a real-life manufactured object, according to an embodiment.

FIG. 7 is a flow chart illustrating sub-steps of the step of calibrating the colors of the display monitor of the electronic graphical communication device of FIG. 6, according to an embodiment.

FIG. 8 is a flow chart illustrating sub-steps of the step of adjusting the parameters of the display monitor of the electronic graphical communication device according to current lighting conditions of FIG. 7, according to an embodiment.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the system for interactive virtual lighting of a virtual sample representative of a real-life manufactured object and corresponding parts thereof consist of certain several components, as explained and illustrated herein, not all of these components are essential and thus should not be taken in their restrictive sense. It is to be understood, as also apparent to a person skilled in the art, that other suitable components and cooperation thereinbetween may be used for the system for interactive virtual lighting of a virtual sample representative of a real-life manufactured object, as will be briefly explained herein and as can be easily inferred herefrom by a person skilled in the art. Moreover, although the embodiments as illustrated in the accompanying drawings comprise particular steps of a method, not all of these steps are essential and thus should not be taken in their restrictive sense.

Broadly described, the system and method for interactive virtual lighting of a virtual sample representative of a real-life manufactured object are designed to provide an interactive virtual manipulation of a virtual representation of the real-life manufactured object, or a portion thereof, where the color, pattern, texture and/or light reflection properties thereof closely match those of the real-life manufactured object. The system and method take into account the color rendering capabilities of the display monitor used to display the virtual sample and the current lighting conditions of the environment of the user in order to provide the closest matching of the color, pattern, texture and/or light reflection properties of the real-life product. Hence, the system and method are destined to allow the user to recreate an experience as close as possible to the experience of a user manipulating a physical sample of the real-life manufactured object (for example as is commonly the case in a showroom of a manufacturer or a distributor of the product) in order to allow the user to choose between a plurality of available products.

One skilled in the art will understand that the real-life manufactured object can be any physical object with a colored, textured and/or light reflecting surface to be represented in virtual form to a user. The term “manufactured” is used herein to refer to industrially produced goods or wares using manual labor or machinery and encompasses objects made from synthetic material, such as laminate materials, as well as objects made from natural material, such as granite, quartz, marble or the like. One skilled in the art will understand that such real-life manufactured object can be, for example and without being limitative flooring, countertop surfaces, composite panels, decorative surfaces, textiles and the like for which users are commonly required to select a preferred product and/or finish amongst a plurality of available products and/or finishes.

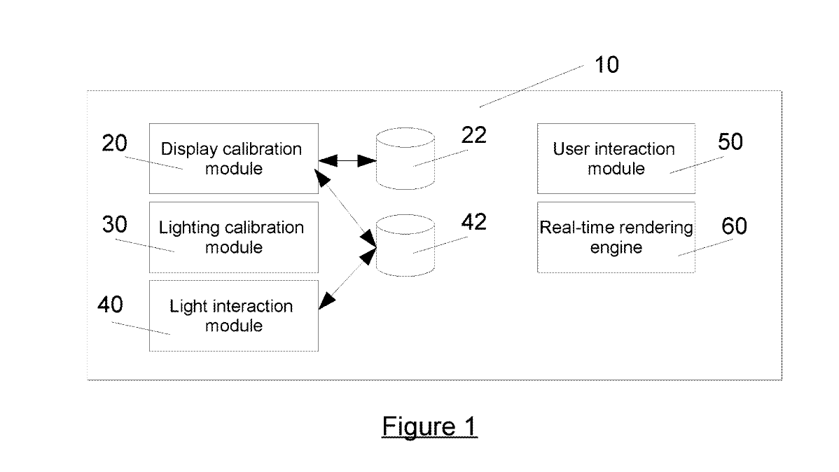

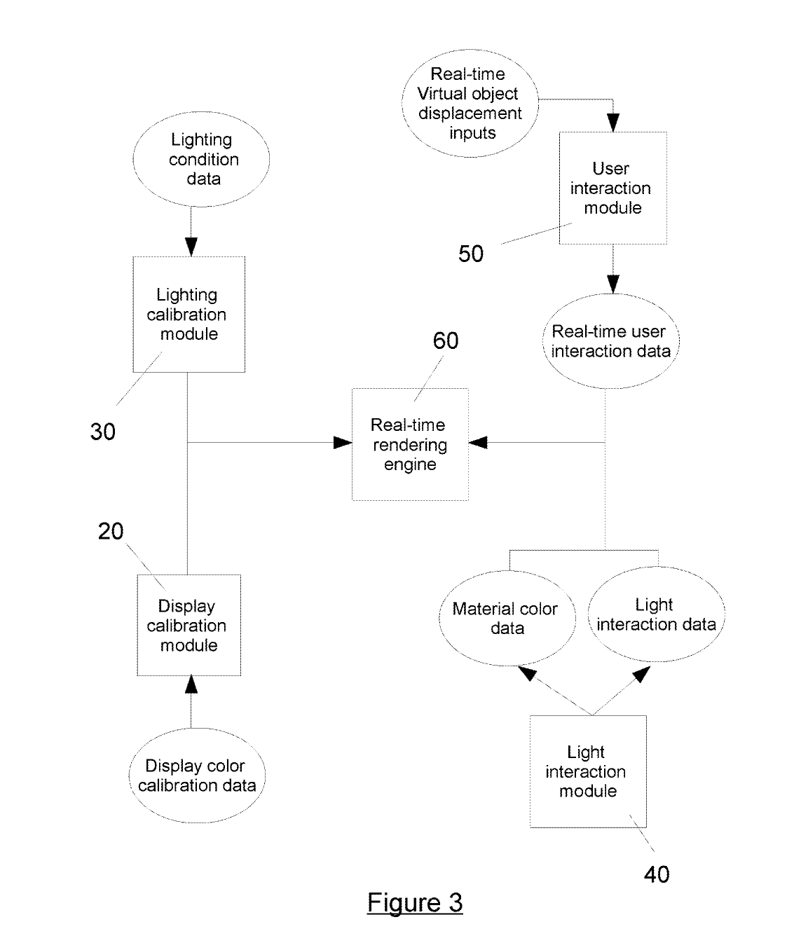

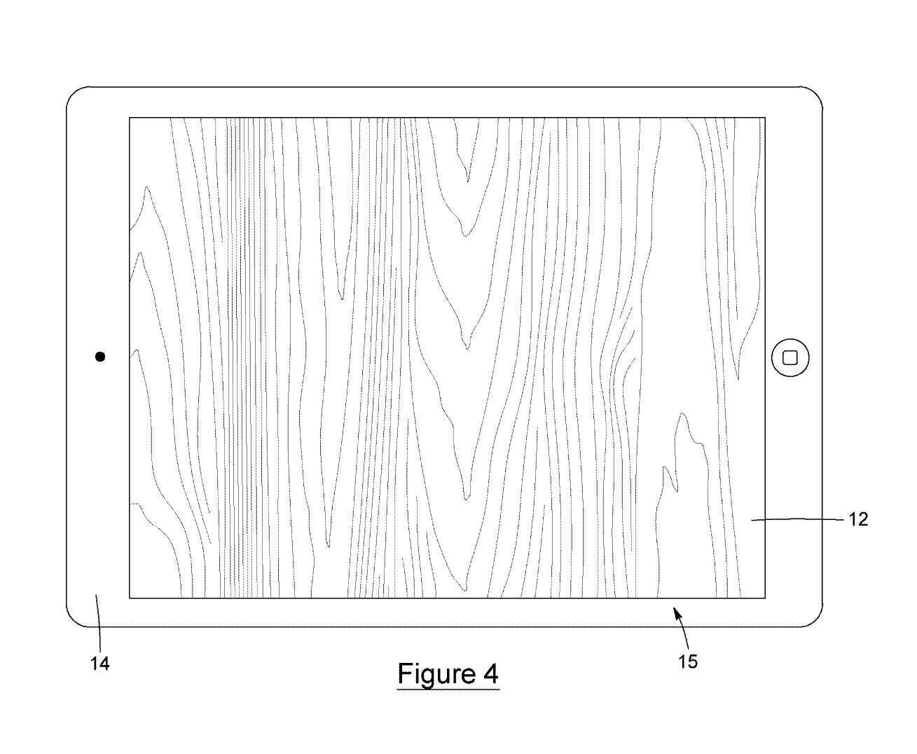

Referring generally to FIGS. 1 to 4, an embodiment of a system 10 for providing interactive virtual lighting of a virtual sample 12 representative of a real-life manufactured object, where the virtual sample 12 accurately depicts the real-life manufactured object for the specific parameters of the user's display monitor and the current lighting conditions of the user's environment, is shown. In an embodiment, the virtual sample 12 is a three-dimensional (3D) representation of the virtual sample. One skilled in the art will however understand that, in an alternative embodiment, the virtual sample can be a different representation of geometric data, such as a two-dimensional representation.

In an embodiment, the system 10 is installed on an electronic graphical communication device 14 having a memory for storing instructions, data and the like and a processor. In the present document, the term “electronic graphical communication device” is used to refer to any electronic device allowing the display of graphical information on a display monitor operatively connected thereto and having data input devices. The data input devices can be user input devices such as for example and without being limitative, a keyboard, a mouse, a tactile screen, an accelerometer, a gyroscope, a compass, or the like, which allow interaction between the user and the device 14, or any other components allowing data input, such as cameras, sensors or the like. For example and without being limitative, the electronic graphical communication device can include devices such as electronic tablets, smartphones, laptop computers, desktop computers and the like. One skilled in the art will also understand that, in an alternative embodiment (not shown), the system 10 can be fully or partly installed on one or more remote computing device (s), such as server(s) or the like, and be fully or partly accessed by the electronic graphical communication device 14 communicating with the system 10 over a network, such as, for example and without being limitative, a local area network (LAN) or a wide area network (WAN), such as the Internet, or the like. In the description below, the term “display monitor” is used in the singular form, but one skilled in the art will understand that more than one display monitor can be associated to the electronic graphical communication device 14. For example and without being limitative, the display monitor 15 can be a single display screen, multiple display screens, display optics of a head mounted display, or the like.

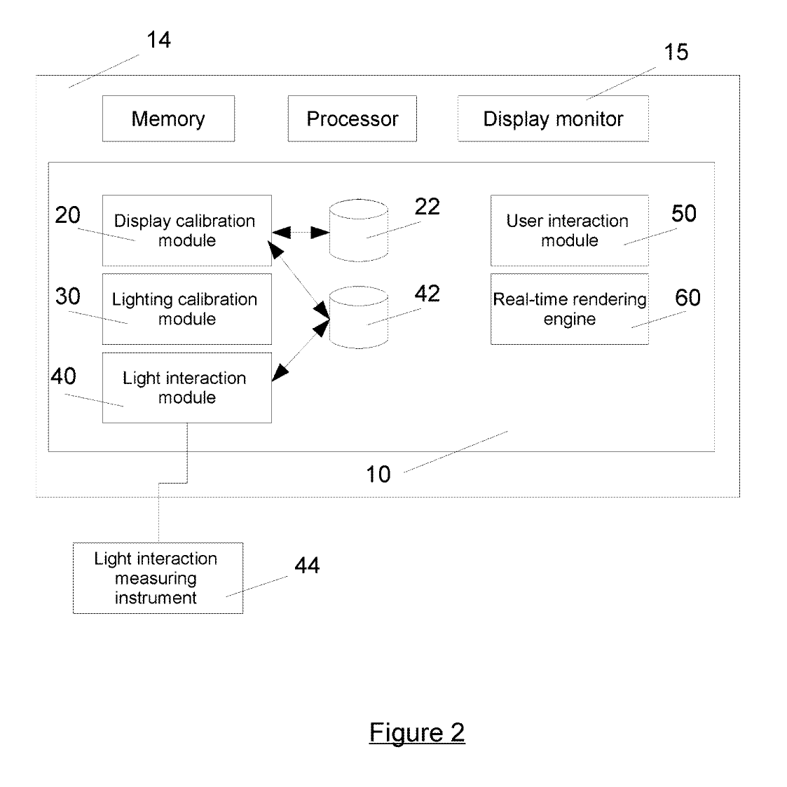

In the embodiment shown, the system 10 includes a display calibration module 20, a lighting calibration module 30, a light interaction module 40, a user interaction module 50 and a real-time rendering engine 60. The display calibration module 20, lighting calibration module 30, light interaction module 40 and user interaction module 50 cooperate with the real-time rendering engine 60 in order to allow the real-time or near real-time display of the virtual sample 12 substantially visually matching the real-life product for the specific display monitor 15 and the specific current environment of the user when the virtual sample 12 is displayed. The display calibration module 20, lighting calibration module 30, light interaction module 40, user interaction module 50 and real-time rendering engine 60 each can be implemented as software, hardware, or a combination of software and hardware. Moreover, they each can be implemented as singular entities cooperating with the other entities, as shown in the embodiment shown in FIGS. 1 and 2, or at least two of the display calibration module 20, lighting calibration module 30, light interaction module 40, user interaction module 50 and real-time rendering engine 60 can be combined in a same entity of software, hardware or a combination thereof. In view of the above, one skilled in the art will understand that the display calibration module 20, lighting calibration module 30, light interaction module 40, user interaction module 50 and real-time rendering engine 60 can be installed on a single computing device or be distributed over multiple computing device(s) operatively connected to one another, for example over a network.

In an embodiment, the light interaction module 40 is initially used to measure light interaction parameters of the real-life manufactured object and generate light interaction data and material color data therefrom. In other words, the light interaction module 40 generates light interaction data and material color data through measure of the light interaction with the real-life manufactured object. Such light interaction data and material color data are generated for each relevant real-life manufactured object (i.e. each manufactured object that is to be possibly displayed as a virtual sample in the system 10). In an embodiment, the light interaction data and material color data are stored in a light interaction database 42. One skilled in the art will understand that, in alternative embodiments (not shown), other storing means different than a dedicated database can also be used for storing the generated light interaction data and/or material color data. The stored light interaction data and material color data are subsequently used by the system 10, as will be described in more details below, in order to generate the virtual sample which accurately depicts the corresponding real-life manufactured object.

In an embodiment, the light interaction data is generated by the light interaction module 40 using a light interaction measuring instrument 44 operatively connected to the light interaction module 40 and operative to measure light interaction parameters. For example and without being limitative, in an embodiment the light interaction measuring instrument 44 can be a dedicated sample scanner, such as a flat scanner or a 3D scanner. In other alternative embodiments, other light capturing devices, such as a camera system or the like can be used for the light interaction measuring instrument 44. The light interaction measuring instrument 44 is used to scan the surfaces of the real-life manufactured object and to generate surface elevation data and/or light reflectivity data including at least one of a bump map, a normal map, a reflection map, a specular map, a Bidirectional Reflectance Distribution Function (BRDF), a Bidirectional Texture Function (BTF), a Spatially Varying Bidirectional Reflectance Distribution Function (SVBRDF) and a Bidirectional Surface Scattering Reflectance Distribution Function (BSSRDF), for the specific real-life manufactured object.

In the course of the present document, the term “operatively connected” is used to refer to components being in data communication with one another, for example and without being limitative by being part of the same physical unit, not being part of the same physical unit but being physically connected to one another, for example via a wire or the like, not being part of the same physical unit and being connected by data transmission mean other than physical connection, for example over a wireless personal area network (WPAN), wireless local area networking (ALAN), or the like.

In an embodiment, the material color data representative of the color of the real-life manufactured object is also generated through the light interaction module 40, using the light interaction measuring instrument 44 operatively connected thereto. The light interaction measuring instrument 44 is once again used to scan the real-life manufactured object and to generate the material color data associated to the virtual sample 12 to be displayed on the display monitor 15 of the electronic graphical communication device 14.

One skilled in the art will understand that, in an embodiment (not shown), the light interaction data and/or material color data can be generated by an external source (a source independent from the light interaction module 40) and be imported or accessed by the system 10. For example and without being limitative, the light interaction data and/or material color data can be external data stored on a remote database, with the system 10 being in data communication with the remote database, to allow data access or data transfer of the light interaction data and/or material color data stored on the remote database.

In an embodiment, the light interaction module 40 allows validation and/or fine-tuning (i.e. correction) of the light interaction data and/or material color data gathered by the light interaction measuring instrument 44.

In an embodiment, the validation and/or fine-tuning can be performed manually, by an operator, through manual comparison of the light interaction between the real-life object and a generated preliminary virtual sample displayed to the operator on a color calibrated display monitor. In the course of the present document, the term “operator” is used to refer to a person interacting with the real-life manufactured object in order to gather and/or validate the light interaction parameters of the real-life manufactured object.

In more details, in an embodiment, the manual validation can be performed by the operator visually comparing the real-life object and a preliminary virtual sample displayed by the real time rendering engine 60 on a color calibrated display monitor, based on the gathered light interaction data and/or material color data. During the comparison, the operator can perform fine-tuning of the parameters of the light interaction corresponding to the surface elevation data and/or the light reflectivity data and/or the material color data until the virtual dynamic lighting and the color of the preliminary virtual sample displayed to the operator on the color calibrated monitor matches the behavior of the light with the real-life manufactured object and the color thereof. In an embodiment, the visual comparison by the operator is performed in a room with a controlled light environment to favor a precise matching between the fine-tuned preliminary virtual sample displayed and the real-life manufactured object.

In an alternative embodiment, the light interaction module 40 can be configured to perform the validation and/or fine-tuning of the light interaction data and/or material color data through an automated process comparing the light interaction between the real-life object and the generated preliminary virtual sample displayed on a display monitor.

For example and without being limitative, in an embodiment, the automated validation and/or fine-tuning of the light interaction data and/or material color data can be performed using a camera with color sensitivity parameters substantially similar to the color sensitivity of the human eye and a specialized light interaction tuning unit, which can once again be implemented as software, hardware, or a combination of software and hardware. In other words, the spectral sensitivity of the camera substantially matches or is substantially analogous to the spectral sensitivity of the human eye. In such an embodiment, the validation can be performed by the camera recording images of the real-life object and the preliminary virtual sample displayed on a color calibrated display monitor and transmitting the images to light interaction tuning unit. The light interaction tuning unit analyzes the images recorded by the camera and iteratively compares the image data of the two subregions of the images corresponding to the real-life product and the preliminary virtual sample and adjusts the parameters of the light interaction corresponding to the surface elevation data and/or the light reflectivity data and/or the material color data until the virtual dynamic lighting and the color of the preliminary virtual sample and the behavior of the light with the real-life manufactured object and the color thereof satisfy a matching threshold of the light interaction tuning unit. In an embodiment, the automated validation and/or fine-tuning of the light interaction data and/or material color data is once again performed in a room with a controlled light environment to favor a precise matching between the fine-tuned preliminary virtual sample displayed and the real-life manufactured object.

When validation and/or fine-tuning of the light interaction data and/or material color data is performed, either manually or through an automated process, the light interaction module 40 allows update of the light interaction data and/or color data based on the fine-tuning of the parameters for the specific real-life manufactured object and/or finish. In an embodiment, the updated light interaction data and/or material color data are stored in the light interaction database 42 and are subsequently used as light interaction data and/or material color for the specific real-life manufactured object.

In an embodiment, the display calibration module 20 is configured to perform color calibration based on display color calibration data of the display monitor 15 of the electronic graphical communication device 14. In an embodiment, the display calibration module 20 allows the display monitor 15 to be calibrated, such that the colors of the virtual sample 12 are the same for each display monitor 15, thereby contributing to the colors of the virtual sample 12 matching the colors of the real-life manufactured object when displayed on the specific display monitor 15 used by the user to visualise the virtual sample. In an alternative embodiment, the colors of the virtual sample are calibrated to adapt to the specific display monitor 15 used by the user to visualise the virtual sample. In other words, in such an embodiment, the material color data representative of the color of the real-life manufactured object are adjusted according to the display color calibration data of the specific display monitor 15 used by the user to visualise the virtual sample, such that the colors of the virtual sample 12 are the same for each display monitor 15.

In an embodiment, the display color calibration data includes device color profiles (e.g. an ICC profile) generated for display monitors 15 which can be associated with the electronic graphical communication device 14. In an alternative embodiment, the display color calibration data can also include device color profiles (e.g. an ICC profile) generated for a specific electronic graphical communication devices 14 for which the display monitor is always the same. For example and without being limitative, this can be the case for electronic tablet computers, for which the display monitor 15 is always the same for a specific tablet brand and model. Techniques, process and methods for generating display color calibration data including color profiles for specific display monitors 15 (or specific electronic graphical communication devices 14 associated to a specific display monitor) are well known in the art. In an embodiment, the display color calibration data generated for each specific display monitor 15 or electronic graphical communication devices 14 is stored in a color profile database 22 accessible by the display calibration module 20.

As mentioned above, in an embodiment, the display calibration module 20 performs color calibration by calibrating the display monitor 15 of the electronic graphical communication device 14 using display color calibration data specific to the particular display monitor 15 of the electronic graphical communication device 14 used by the user or to the specific electronic graphical communication devices 14. Hence, in an embodiment, device color profiles are generated for specific display monitors possibly being used as display monitor 15 of the electronic graphical communication device 14 and/or for specific electronic graphical communication devices 14 for which the display monitor is always the same. In such embodiments, the display calibration module 20, is configured to identify the display monitor being used or the specific electronic graphical communication device 14 and performs color calibration of the display monitor 15 of the electronic graphical communication device 14 based on the device color profile previously generated for the specific identified display monitor 15 or the specific electronic graphical communication device 14.

A mentioned above, in an alternative embodiment, the display calibration module 20 can also perform color calibration by calibrating the colors of the virtual sample (i.e. the material color data representative of the color of the real-life manufactured object generated by the above-described light interaction module 40) to adapt to the specific display monitor 15 used by the user to visualise the virtual sample. In fact, one skilled in the art will understand that, the display calibration module 20 is especially relevant for electronic graphical communication device 14, which do not allow easy color calibration of the associated display monitor 15, such as, without being limitative several types of electronic tablet computers. Hence, for example and without being limitative, in an embodiment where the electronic graphical communication device 14 used by the user is an electronic tablet computer (where a specific tablet brand and model always has the same display monitor 15), the data relative to the tablet brand and model can be gathered during the installation process of the system 10 on the tablet and the device color profile associated to the particular electronic graphical communication devices 14 (i.e. the specific tablet brand and model) can be stored in the memory of the tablet when the system 10 is installed thereon. The display calibration module 20 can include instructions (or computer code) configured to automatically perform color calibration of the virtual sample (i.e. automatically adjust the generated material color data) for this particular tablet brand and model, using the device color profile stored in the memory of the tablet. Hence, when the virtual sample 12 is displayed on the display monitor 15 thereof, the virtual sample is color calibrated such that the colors of the virtual sample 12 closely match those of the real-life manufactured object.

It will be understood that to perform color calibration, the display calibration module 20 requires identification of the specific display monitor 15 or the specific electronic graphical communication device 14, in addition to the initial generation of the device color profile specific to the identified display monitor 15 or electronic graphical communication device 14. In an embodiment where the specific display monitor 15 of the electronic graphical communication device 14 cannot be identified and/or if no previous generation of the device color profile of the identified display monitor 15 or electronic graphical communication device 14 has been performed, the display calibration module 20 will not perform the color calibration. For example and without being limitative, this is most likely to occur in embodiments where the system 10 is accessed via a laptop or desktop computer, through a computer network (i.e. via a web interface), such that the display monitor 15 cannot be easily identified.

One skilled in the art will understand that, in alternative embodiments (not shown), color calibration of the display monitor 15 of an electronic graphical communication device 14 can sometimes also be performed by the user, independently of the display calibration module 20. Methods and process for performing color calibration for example manually (by eye) or using a color calibrator (or colorimeter) are known in the art and can be performed by a user when the operating system of the associated electronic graphical communication devices 14 allows access to calibration parameter of the associated display monitor 15.

The lighting calibration module 30 is operative to generate lighting condition data representative of the current lighting conditions of the immediate environment of the user, at the specific time where the user wishes to visualize the virtual sample 12, and to adjust at least one parameter of the virtual light source lighting the virtual sample 12 (e.g. light color (RGB or hue) and light intensity (brightness)) according to the generated lighting condition data. The lighting calibration module 30 therefore operates to compute the lighting condition data, determine the parameters of the virtual light and adjust the parameters of the virtual light source lighting the virtual sample 12 according to the current lighting conditions in which the user is when using the system 10, such that the displayed virtual sample 12 appears as the real-life manufactured object would appear in these specific lighting conditions. In the present application, the term “immediate environment” of the user is used to define the close surroundings of the user at a precise moment.

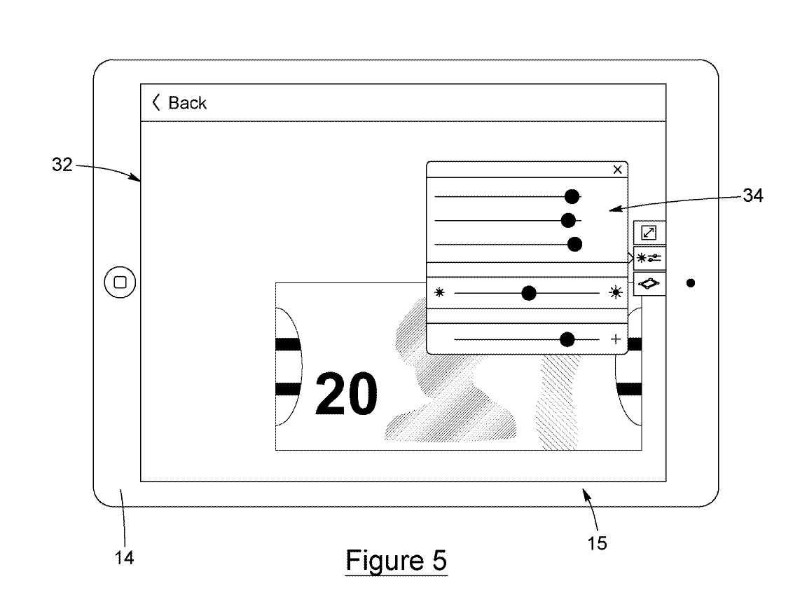

Referring to FIG. 5, in an embodiment, the lighting calibration module 30 uses a lighting calibration interface 32 to perform a user-driven lighting condition input process where the user manually adjusts the parameters of the virtual light source lighting the virtual sample 12, through a comparison of the color of a physical object currently in its possession with that of a virtual object shown on the display monitor 15 of the electronic graphical communication device 14 in order to generate the lighting condition data. For example and without being limitative, the physical object in the possession of the user can be a common object (e.g. a coin, a dollar bill, a credit card, or the like), a flyer previously transmitted to the user with colors printed thereon, the frame of the graphical communication device itself (taking into account the specific brand and model thereof), or any other object in the possession of the user for which the exact real-life color is known to the lighting calibration module 30.

In an embodiment (not shown), the lighting calibration interface 32 of the lighting calibration module 30 initially displays a list of possible physical objects to be used by the user to perform the user-driven lighting condition input process, on the display monitor 15, and allows selection of at least a first one of the physical object by the user, using the input devices of the electronic graphical communication device 14. Upon selection of the physical object from the list by the user, the lighting calibration interface 32 displays a virtual image representative of the physical object selected, or at least a color thereof, and lighting adjustment controls 34 on the display monitor 15 (see FIG. 5 wherein the physical object is a 20$ bill). For example and without being limitative, in an embodiment, the lighting adjustment controls 34 are graphical control elements such as scrollbars or sliders controllable by the user using an input device of the electronic graphical communication device, and which allow the adjustment of one or a combination of parameters of the virtual light source lighting the virtual sample 12, by the user, through movement of an indicator thereof. The parameters of the virtual light source lighting the virtual sample 12 in the lighting calibration interface 32, are repeatedly adjusted to modify the lighting of the virtual image of the selected physical object displayed in the lighting calibration interface 32 in real-time or near real time, based on the input of the user (the input given by the user using the lighting adjustment controls 34 of the lighting calibration interface 32). Hence, the user can adjust the parameters of the virtual light source lighting the virtual sample 12 until it is satisfied that the virtual image shown in the lighting calibration interface 32 matches the color and lighting of the physical object currently in its possession, according to the current lighting conditions.

In an embodiment, the lighting calibration interface 32 allows numerous iterations of the above described selection of a real-life object and corresponding adjustment of the lighting parameter by the user until it is satisfied that the virtual image shown in the lighting calibration interface 32 matches the color and lighting of the physical object currently in its possession, according to the current lighting conditions. In fact, one skilled in the art will understand that performance of multiple iterations during the user-driven input process will generally increase the accuracy of the lighting calibration data gathered by the lighting calibration module 30 and therefore lead to realistic looking virtual samples 12 regarding their real-life counterparts, when subsequently displayed under the current lighting conditions.

In an alternative embodiment (not shown), the lighting calibration module 30 can also generate lighting calibration data automatically (i.e. without requiring performance of the above-described user-driven process) using lighting condition inputs provided by light capture component(s) operatively connected to the electronic graphical communication device 14, such as a camera, a light sensor, or the like. One skilled in the art will understand that such automatic generation of lighting calibration data can be supplemental to the previously described user-driven process or independent therefrom. In an embodiment where the automatic generation of lighting calibration data is supplemental to the previously described user-driven process also for generating lighting calibration data, the lighting calibration data generated using both process can be combined and/or processed to generate the resulting lighting calibration data subsequently used by the lighting calibration module 30, as described in more details below.

Referring again to FIGS. 1 to 4, as mentioned above, once the lighting condition data is generated, the lighting calibration module 30 adjusts at least one parameter of the virtual light source lighting the virtual sample 12 (e.g. light color and light intensity) of the real-time rendering engine 60 according to the generated lighting condition data, in order to match the virtual light source lighting the virtual sample 12 to the current lighting conditions of the user. One skilled in the art will understand that, in an embodiment, the lighting calibration module 30 is configured to generate lighting condition data and perform the corresponding adjustment of the at least one parameter of the virtual light source lighting the virtual sample 12 each time the lighting conditions of the immediate environment of the user is susceptible to substantially have change, in order to better match the lighting of the virtual object 12 to the current lighting conditions of the user. For example and without being limitative, the lighting calibration module 30 could prompt the user to perform the user driven process for generating lighting calibration data and/or perform the automatic generation of lighting calibration data every time the system has not been used for a specific time period and/or when a position of the electronic graphical communication device 14 changes, or when any other condition indicative of a possible change in lighting conditions of the immediate environment of the user is met.

In an embodiment, the user interaction module 50 captures real-time movement of the virtual sample 12 generated by the user, using real-time virtual object displacement inputs from one or more input devices of the electronic graphical communication device 14, such as mouse inputs, keyboard inputs, gyroscope inputs, accelerometer inputs, compass inputs, touchscreen inputs, virtual reality headset inputs, or the like and generates real-time user interaction data therefrom.

For example and without being limitative, in an embodiment where the electronic graphical communication device 14 is an electronic tablet, the user interaction module 50 can capture change in positioning of the tablet in real-time, such as rotation and/or tilting thereof, using at least one of the gyroscope, the accelerometer and the compass of the tablet and generate real-time user interaction data representative of such movements, in order to simulate movements of the object similar to the movements of the tablet by the user.

In an embodiment, the real-time rendering engine 60 simulates light interaction with the virtual sample 12 in order to reproduce the light behavior of natural light with the real-life manufactured object. The real time rendering engine 60 uses the material light Interaction data and the material color data from the light interaction module 40 and the real-time user interaction data from the user interaction module 50, in order to simulate the light behavior from at least one virtual light source with the virtual sample 12, as the virtual sample 12 is moved according to the real-time user interaction data. In other words, the real time rendering engine 60 continuously processes the real-time user interaction data from the user interaction module 50 and the light Interaction data from the light interaction module 40 to display the accurate light pattern on the virtual sample 12, according to the continuously changing position of the at least one virtual light source with regards to the virtual sample 12.

In view of the above, the combination of the display calibration module 20, lighting calibration module 30, light interaction module 40, user interaction module 50 and real-time rendering engine 60 allows the desired interactive virtual sample manipulation and visualization simulating the depth information and/or light reflection information of the real-life manufactured object, and takes into account the parameters of the display monitor 15 used and the environment of the user when the display of the virtual sample 12 occurs, such that the virtual sample 12 accurately depicts the real-life manufactured object in the current environment. In an embodiment, the ratio between the virtual sample 12 and the real-life manufactured object is a 1:1 ratio to accurately depict the real-life manufactured object to the user and therefore helps in selection of a particular product using the sample.

Such accurate representation of the real-life manufactured object in virtual form has several advantages. For example and without being limitative, it can favour the use of virtual representations of the plurality of different products available for purchase to potential buyers rather than physical samples, help decrease the product return rate due to the difference in product appearance between what a consumer saw on an electronic graphical communication device when making a purchase and the product appearance when delivered, or the like.

The system 10 for interactive virtual lighting of a virtual sample 12 representative of a real-life manufactured object having been described above, a computer implemented method for interactive virtual lighting of the virtual sample representative of the real-life manufactured object on the electronic graphical communication device will now be described.

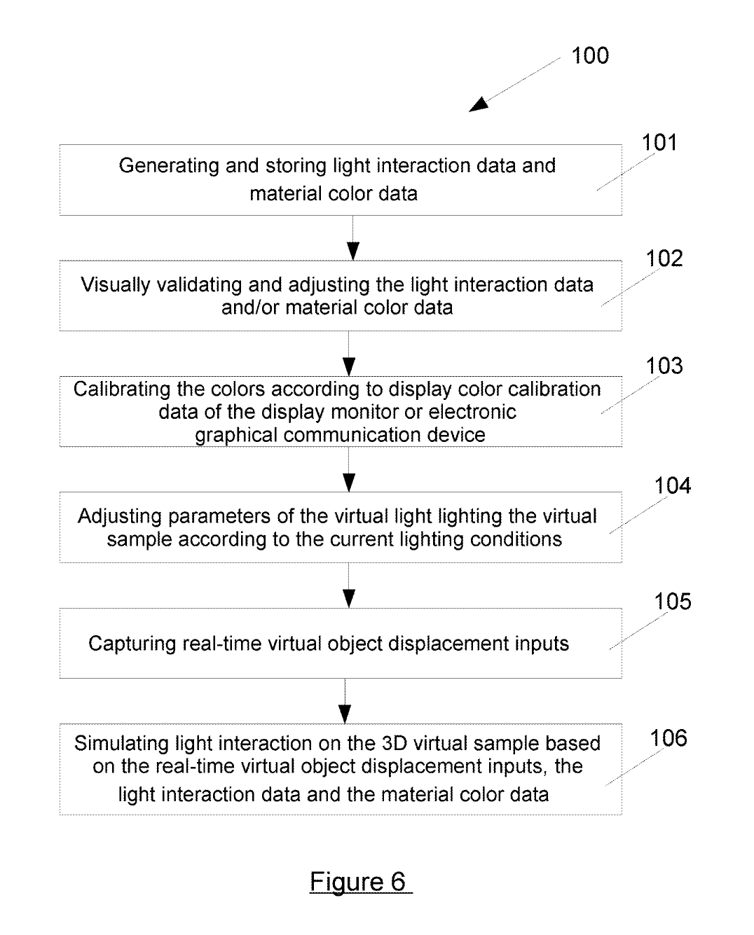

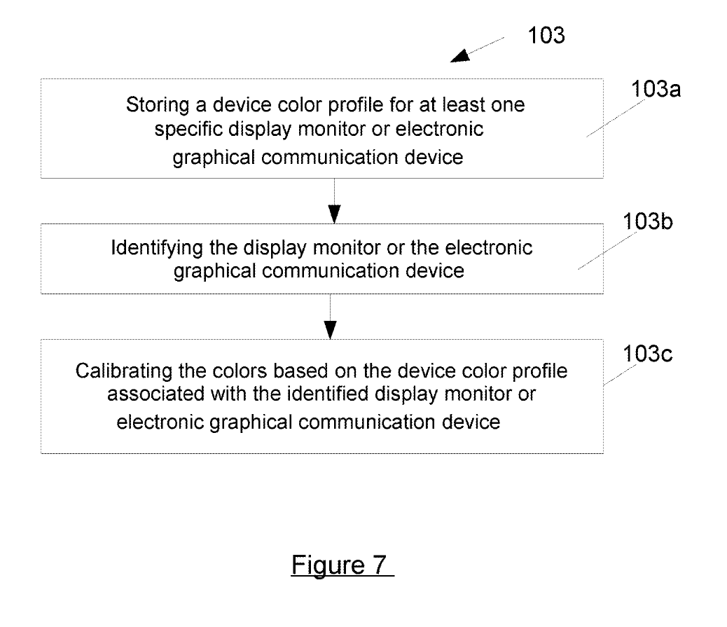

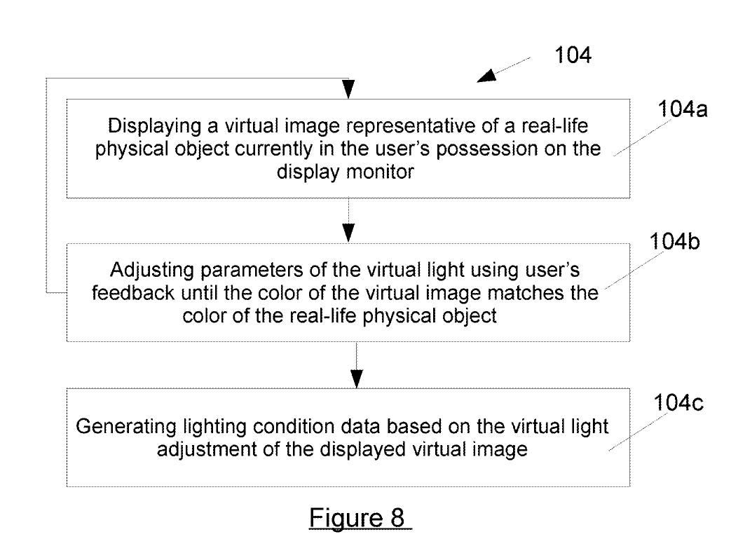

Referring to FIGS. 6 to 8, in an embodiment, the method 100 for interactive virtual lighting of the virtual sample representative of the real-life manufactured object on the electronic graphical communication device comprises an initial step of generating and storing light interaction data and material color data regarding the real-life manufactured object (101). In an embodiment, this step is performed by measuring the light interaction with the real-life manufactured object, using at least one measuring instrument 44 operatively connected to the light interaction module 40 and storing the light interaction data and material color data in a light interaction database. In an embodiment, the method includes a subsequent step of validating the light interaction data and/or material color data and/or adjusting parameters of the light interaction and/or color (102). In an embodiment, this step is performed by a visual comparison of the light interaction and/or color between the real-life object and a preliminary virtual sample displayed to an operator and manual adjustment of parameters of the light interaction and/or color in order to update and store the light interaction data and/or the material color data in the light interaction database. In an embodiment, the visual validation of the light interaction data and/or material color data is performed in controlled light conditions. In an alternative embodiment, the step of validating the light interaction data and/or material color data and adjusting parameters of the light interaction and/or color (102) can also be automated (i.e. be performed without user interaction), using dedicated hardware and software components.

In an embodiment, the method 100 further comprises a step of calibrating the colors of the virtual sample and/or the display monitor of the electronic graphical communication device (103). In an embodiment, this step includes generating and storing a device color profile in a color profile database for at least one specific display monitor or electronic graphical communication device (103a); identifying the display monitor or the electronic graphical communication device on which the system operates (103b); and performing color calibration based on the device color profile associated with the identified display monitor or identified electronic graphical communication device (103c). In an embodiment, performing color calibration includes color calibrating the display monitor of the electronic graphical communication device based on the device color profile associated with the identified display monitor or identified electronic graphical communication device. In an embodiment, performing color calibration includes adjusting the material color data based on the device color profile associated with the identified display monitor or identified electronic graphical communication device.

In an embodiment, the method further comprises the step of generating lighting condition data representative of current lighting conditions and adjusting at least one parameter of the virtual light source lighting the virtual sample based on the lighting condition data (104). In an embodiment, this step includes displaying a virtual image representative of a physical object currently in the user's physical possession on the display monitor of the electronic graphical communication device (104a); adjusting the parameters of the virtual light source lighting the virtual sample using user's feedback until the color and lighting of the virtual image representative of the physical object currently in the user's possession displayed on the display monitor of the electronic graphical communication device matches the color and lighting of the real-life physical object currently in the user's possession (104b) and generating the lighting condition data based on the virtual light adjustment (104c). In an embodiment, steps 104a and 104b are performed sequentially for several real-life physical objects currently in the user's possession.

In an alternative embodiment, the step of generating lighting condition data representative of current lighting conditions comprises acquiring lighting condition inputs from at least one light capture component operatively connected to the electronic graphical communication device, such as a camera, a light sensor, or the like and generating the lighting condition data based on the received lighting condition inputs.

In an embodiment, the method further comprises the step of capturing real-time movement of the virtual sample generated by the user (105) using real-time virtual object displacement inputs of the electronic graphical communication device. One skilled in the art will understand that the real-time virtual object displacement inputs are generated by the user, interacting with the electronic graphical communication device, as mentioned above.

In an embodiment, the method finally comprises the step of simulating light interaction on the virtual sample (106), using the previously stored light interaction data and material color data and the captured real-time movement of the virtual sample. In step 106, the virtual sample is repeatedly moved according to the captured real-time movement of the virtual sample and virtual lighting of the virtual sample 12 is repeatedly processed, based on the known light interaction data and according to the positioning of the at least one virtual light source with regards to the virtual sample.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. A system for interactive virtual lighting of a virtual sample representative of a real-life manufactured object, on an electronic graphical communication device operatively connected to a display monitor, based on light interaction data and material color data relative to the real-life manufactured object, the system comprising:
a lighting calibration module generating user lighting condition data representative of the current lighting conditions of an immediate environment of a user, the lighting calibration module being configured to adjust at least one parameter of a virtual light source lighting the virtual sample according to the lighting condition data;
a user interaction module capturing real-time virtual object displacement inputs from the electronic graphical communication device and generating real-time user interaction data therefrom; and
a real time rendering engine simulating light interaction from the virtual light source with the virtual sample, the real time rendering engine repeatedly moving the virtual sample according to the real-time user interaction data and concurrently repeatedly processing the light interaction data to simulate light interaction from the virtual light with the virtual sample.

2. The system of claim 1, wherein the at least one parameter of the virtual light source lighting the virtual sample comprises at least one of a light color and a light intensity.

3. The system of claim 2, wherein the lighting calibration module is further configured to receive lighting condition inputs from an input device of the electronic graphical communication device and generate the user lighting condition data representative of the current lighting conditions of the immediate environment of the user based on the received lighting condition inputs.

4. The system of claim 3, wherein the lighting calibration module is configured to receive the lighting condition inputs from user controlled lighting adjustment controls, the lighting calibration module comprising a lighting calibration interface in which a virtual image representative of a physical object in possession of the user and the lighting adjustment controls are displayed on the display monitor, the lighting calibration module repeatedly adjusting at least one parameter of a virtual light lighting the virtual image representative of the physical object in possession of the user on the display monitor according to user inputs from the lighting adjustment controls.

5. The system of claim 3, wherein the lighting calibration module is configured to receive the lighting condition inputs from at least one light capture component operatively connected to the electronic graphical communication device.

6. The system of claim 1, further comprising a display calibration module, the display calibration module being configured to perform color calibration based on a device color profile specific to one of the display monitor or the electronic graphical communication device.

7. The system of claim 6, wherein the display calibration module is configured to calibrate the colors of the display monitor based on the device color profile specific to the one of the display monitor or the electronic graphical communication device display monitor.

8. The system of claim 6, wherein the display calibration module is configured to adjust the material color data relative to the real-life manufactured object based on the device color profile specific to the one of the display monitor or the electronic graphical communication device.

9. The system of claim 1, further comprising a light interaction module configured to measure light interaction parameters relative to the real-life manufactured object and generate the light interaction data and material color data therefrom.

10. The system of claim 9, wherein the light interaction module comprises a light interaction measuring instrument operative to measure the light interaction parameters relative to the real-life manufactured object.

11. The system of claim 10, wherein the light interaction measuring instrument comprises at least one of a flat scanner and a 3D scanner.

12. The system of claim 9, wherein the light interaction module further comprises:
a camera having color sensitivity parameters substantially similar to the color sensitivity of the human eye, the camera being operatively connected to the electronic graphical communication device and being operative to record images of the real-life object and a preliminary virtual sample displayed on a color calibrated display monitor based on the generated light interaction data and material color data; and
a light interaction tuning unit receiving the images recorded by the camera and iteratively comparing image data of the real-life object and the preliminary virtual sample from the images and adjusting the parameters of the light interaction data and material color data until a matching threshold is met.

13. A computer implemented method for performing interactive virtual lighting of a virtual sample representative of a real-life manufactured object, on an electronic graphical communication device having a display monitor and based on light interaction data and material color data relative to the real-life manufactured object, the method comprising the steps of:
generating lighting condition data representative of the current lighting conditions of an immediate environment of a user and adjusting at least one parameter of a virtual light source lighting the virtual sample based on the lighting condition data;
capturing real-time virtual object displacement inputs from the electronic graphical communication device and generating real-time user interaction data therefrom;
repeatedly moving the virtual sample on the display monitor according to the real-time user interaction data; and
repeatedly processing the light interaction data to simulate light interaction with the virtual sample displayed on the display monitor.

14. The computer implemented method of claim 13, wherein generating lighting condition data representative of the current lighting conditions comprises:
displaying a virtual image representative of a physical object in possession of the user and at least one lighting adjustment control on the display monitor;
adjusting at least one parameter of the virtual light source lighting the virtual image, using the at least one lighting adjustment control, to adjust the lighting of the displayed virtual image representative of the physical object, until the color and lighting of the physical object in the current lighting conditions and the color and lighting of the displayed virtual image visually match;
generating the lighting condition data based on the adjustment of the at least one parameter of the virtual light source lighting the virtual image.

15. The computer implemented method of claim 13, wherein generating lighting condition data representative of the current lighting conditions comprises acquiring lighting condition input from at least one light capture component and generating the lighting condition data based on the received lighting condition input.

16. The computer implemented method of claim 13, further comprising the step of performing color calibration based on a device color profile specific to one of the display monitor or the electronic graphical communication device.

17. The computer implemented method of claim 16, wherein performing color calibration comprises calibrating the colors of the display monitor based on the device color profile specific to the one of the display monitor or the electronic graphical communication device display monitor.

18. The computer implemented method of claim 16, wherein performing color calibration comprises adjusting the material color data relative to the real-life manufactured object based on the device color profile specific to the one of the display monitor or the electronic graphical communication device.

19. The computer implemented method of claim 13, further comprising:
measuring light interaction parameters relative to the real-life manufactured object;
generating the light interaction data and material color data therefrom; and
storing the light interaction data and the material color data.

20. The computer implemented method of claim 19, further comprising validating at least one of the light interaction data or material color data and updating the at least one of the light interaction data or material color data.
